(19) United States
(12) Patent Application Publication
(10) Pub. No.: US 2017/0070038 A1
(43) Pub. Date: Mar. 9, 2017

(54) CORROSION AND WEATHER RESISTANT ASSEMBLY FOR A STUFFING TUBE AND A METHOD FOR MAKING A GASKET FOR USE THEREWITH

(71) Applicant: THE PATENT WELL LLC, Fort Worth, TX (US)

(72) Inventors: Matthew Boyd, Fort Worth, TX (US); MIKE DRY, Fort Worth, TX (US); PETER SIBELLO, Benbrook, TX (US); KENT BOOMER, Aledo, TX (US); JEFF BUSBY, Millsap, TX (US)

(21) Appl. No.: 15/290,353

(22) Filed: Oct. 11, 2016

Related U.S. Application Data
(63) Continuation-in-part of application No. 14/151,139, filed on Jan. 9, 2014, now Pat. No. 9,478,953.
(60) Provisional application No. 61/750,558, filed on Jan. 9, 2013.
(60) Provisional application No. 62/276,570, filed on Jan. 8, 2016.

(51) Int. Cl. H02G 3/04; H02G 3/22; B29C 70/54; F16J 15/02; B29C 70/22

(52) U.S. Cl. CPC H02G 3/0462; F16J 15/022; B29C 70/222; B29C 70/541; H02G 3/22; B29K 2995/0007; B29K 2995/0005; B29L 2031/265

(57) ABSTRACT

An elongated, flexible composite gasket member having a knitted wire mesh rope at least partly impregnated with a soft, tacky, flowable, pre-cured polyurethane gel for use in a stuffing tube assembly. The stuffing tube assembly is used in a deck or bulkhead of a ship. The stuffing tube comprises a cable having insulation on a surface thereof, a metallic shielding jacket, and conductors therein, the cable having an exposed section of metallic shielding and non-exposed section; a metallic stuffing tube with an inner cable channel and an at least partly threaded gland nut receiver space, and a constriction between the gland nut receiver space and the inner channel; a gland nut adapted to threadably engage the gland nut receiver space; and a; wherein the cable passes through the gland nut and stuffing tube with the exposed section substantially wrapped in the elongated flexible composite gasket member the gland nut above the elongated flexible composite material and the constriction below. The flexible gasket member is in electrical communication with the cable and the stuffing tube.

This is a continuation-in-part application. This application claims the benefit of, priority to, and incorporates by reference U.S. patent application Ser. No. 14/151,139, filed Jan. 9, 2014, which claims the benefit of and priority to U.S. Patent Application No. 61/750,558 filed Jan. 9, 2013. This application claims the benefit of and priority to 62/276,570 filed Jan. 8, 2016, which is also incorporated herein by reference.

### BACKGROUND OF THE INVENTION

Field of the Invention

Electromagnetic interference (“EMI”) shielding gasket assembly for stuffing tubes in ships.

Background Information

Modern ships, watercraft, buildings, and vehicles often include electronic equipment that is used within the interior, but often has antenna or other functional parts extending outside. For this reason, there must be an electrical communication from the outside that extends through the wall into the interior. The need for watertight seals often require that special allowances be made. Thus, in conventional construction, ships, buildings, vehicles, and the like use stuffing tubes where electrical communication lines (such as electrical cables) extend through the wall, deck or a bulkhead.

In general, a stuffing tube comprises a tubular or cylindrical shell inserted through a deck or bulkhead and attached there via a weld, adhesive, or fastener. The cable extends from the exterior structure (such as mast or antenna) through the stuffing tube and to the electronic equipment. Seals are used around the cable in the interior of the tube, as well as various machined parts that compress the seal. The seals resist water and air flow between the interior and exterior of the ship.

Shipboard waterproof transition fittings, kick pipes or stuffing boxes are provided to route cables between topside and below deck or between bulkheads defining inter-compartmental spaces. Typically a metallic boundary is provided to shunt environmental EMI or electromagnetic pulse (“EMP”) signals to a metallic boundary, such as the ship deck. EMI (also sometimes called radio-frequency interference or “RFI”) is a disturbance that affects an electrical circuit due to either electromagnetic induction or electromagnetic radiation emitted from an external source. The disturbance may interrupt, obstruct, or otherwise degrade or limit the effective performance of the circuit. The source may be any object, artificial or natural, that carries rapidly changing electrical currents, such as the cable extending through the stuffing tube. The ship deck may be envisioned as a system ground plane, for grounding above deck conduit or cable. Without proper grounding to the ground plane, any external substantial EMI source or EMP pulse may penetrate the metallic boundary (deck), enter below decks, and harm susceptible, sensitive electronic equipment.

In FIG. 1, illustrating prior art, a metallic fitting, such as a stuffing tube, is seen to engage and direct a cable to the deck or bulkhead. Moreover, it is seen that conduit insulation is stripped from the fitting to expose at least some of the metallic shield jacket, such that it is inside the fitting. Finally, it may be seen, in the prior art, that a metallic substance, such as a steel wool type compressible material having a multiplicity of filaments, may be jammed into a stuffing tube space beneath the gland nut and the gland nut tightened down. Tightening the gland nut will squeeze some of the air out, and jam the filaments of the steel wool down, so there are multiple electrical paths between the exposed shielding jacket and the metallic stuffing tube. Thus, a strong EMI/EMP generated signal or current on the shield gasket is grounded to the ship deck.

### SUMMARY OF THE INVENTION

A stuffing tube assembly for use with a wall, deck or bulkhead or other suitable location (collectively “metallic shell”) of a ship, building or other vehicle, the stuffing tube may comprise a cable having insulation on a surface thereof, a metallic shielding jacket, and conductors therein. The cable may have an exposed section of metallic shielding and non-exposed section. A metallic stuffing tube is provided with an inner cable channel and an at least partly threaded gland nut receiver space, and a constriction between the gland nut receiver space and the inner channel. A gland nut is adapted to threadably engage the gland nut receiver space. An elongated, flexible composite gasket member comprising a conductive member, such as a knitted wire mesh rope, may be at least partly impregnated with a soft, tacky, flowable, pre-cured polyurethane gel. The cable passes through the gland nut and stuffing tube with the exposed section substantially wrapped in the elongated, flexible composite gasket member. The gland nut is above the elongated flexible composite material and the constriction below. The flexible gasket member is typically in electrical communication with the cable and the stuffing tube.

A stuffing tube assembly for use with a deck or bulkhead (collectively “metallic shell”) of a ship, the stuffing tube comprising: a cable having insulation on a surface thereof, a metallic shielding jacket, and conductors therein. The cable may have an exposed section of metallic shielding and non-exposed section. A metallic stuffing tube has an inner cable channel and an at least partly threaded gland nut receiver space, and a constriction between the gland nut receiver space and the inner channel. A gland nut is adapted to threadably engage the gland nut receiver space. An elongated, flexible composite gasket member comprising a conductive member having multiple layers of conductive fibers, in one embodiment, is only partly impregnated or saturated with a soft, tacky gel, the elongated, flexible composite gasket member having a cross-sectional area, the x-sectional area comprising a predetermined percentage range of gel to void. The cable passes through the gland nut and stuffing tube with the exposed section substantially wrapped in the elongated flexible composite gasket member the gland nut so as to cause conductive member to contact the stuffing tube and metallic shielding, above the elongated flexible composite material and the constriction below. The conductive member may comprise multiple layers of a knitted wire mesh rope and a predetermined range is about 10-30%, about 10-50% or about 50%. The conductive member may have multiple layers of a knitted wire mesh rope and the predetermined range is about 10-50%. The conductive member may have multiple layers of a knitted wire mesh rope.

A gasket member is disclosed for use in a stuffing tube assembly of a ship said stuffing tube assembly having a cable passing through it. The gasket member may comprise: a wire mesh rope at least impregnated in a pre-selected range with a soft, tacky gel in a selected volume range of gel to void. The gasket member may be elongated and flexible. The wire mesh rope may be conductive and has multiple layers of a knitted wire mesh rope. The predetermined range may be about 10-30%. The conductive member may be multiple layers of a knitted wire mesh rope. The predetermined range may be about 10-50%.

A stuffing tube assembly is provided for use with a deck or bulkhead (collective “metallic shell”) of a ship. The stuffing tube assembly may comprise: a cable having insulation on part of a surface thereof, a metallic shielding jacket, and conductors therein. The cable has an exposed section of the metallic shielding jacket and non-exposed section. A metallic stuffing tube has an exterior surface, an inner cable channel, and an at least partly threaded gland nut receiver space, and a constriction between the gland nut receiver space and the inner channel. A gland nut is adapted to at least partly threadably engage the part of the gland nut receiver space. A multi-fiber disorganized conductor mass is provided. The cable passes through the gland nut and stuffing tube with the exposed section of the cable contacting the fibers of the conductive mass and the adjacent inner walls of the metallic stuffing tube.

A multi-layer weatherproof wrap or coating may, optionally be provided to any of the embodiments disclosed herein, to cover the exterior surface of the stuffing tube and an exposed surface of the gland nut. The conductive mass may include a flexible conductive rope member. The conductive mass may include a gel; wherein said gel is made from pre-cured polyurethane. The multi-layer weatherproof coating may include an inner layer of tacky gel tape and a moisture-proof outer layer.

A stuffing tube assembly, including a stuffing tube, for use with a deck or bulkhead (collectively “metallic shell”) of a ship is provided. The stuffing tube is for receiving a cable, the cable having insulation on at least part of a surface thereof, the cable having an exposed section comprising a metallic shielding jacket, and non-exposed section and conductors inside the metallic shielding jacket. The stuffing tube being metallic has an inner cable channel and an at least partly threaded conductor and gland nut receiver space, and a constriction between the conductor and gland nut receiver space and the inner channel. A gland nut is adapted to threadably engage part of the conductor and gland nut receiver space. An elongated, flexible composite gasket member comprising an electrical conductive member having multiple conductive fibers is provided, the elongated, flexible composite gasket member only partly and not fully saturated with a soft, tacky gel. The elongated, flexible composite gasket member may have a predetermined weight ratio of gel/conductive fiber. The cable passes through the gland nut and stuffing tube and has the exposed section substantially wrapped in the elongated flexible composite gasket member. The gland nut engages the composite gasket member so as to cause the conductive fibers of the electrical conductive member to contact the stuffing tube and the metallic shielding. A weight ratio of gel/conductor of the composite gasket member may be between 20/80 and 80/20.

A method of making an EMI protected and weather and corrosion protected stuffing tube assembly from a stuffing tube and gland nut is provided. A dry metallic conductor comprising multiple disorganized fibers and a two-part curable mix comprising a resin and a hardener is added to the stuffing tube, such that at least some of the conductor is adjacent the exposed section of the cable. Rotating the gland nut into the stuffing tube squeezes the contents of the stuffing tube such that the gel spreads and the conductor grounds the metallic shield. The curable mix may include a gel having gel time of about 4-20 minutes. The curable mix may reach full cure in about 1-4 hours. The curable mix of the inserting step may cure to a gel. The curable mix is typically applied with an applicator that mixes the hardener and resin as it inserts it into the stuffing tube. The mix may have a viscosity of between about 1500 and 4400 cP (centipoise) when mixed and that increases over time. The mix, in one embodiment, may have a viscosity of between about 20,000 and 65,000 cP when mixed and that increases over time. The more viscous mix may be injected first, followed by the conductor then followed by the less viscous mix.

A method of making an EMI protected and weather and corrosion protected stuffing tube assembly from a stuffing tube and a gland nut is disclosed. The method comprises the step of, with the gland nut removed and a cable running through the stuffing tube (the cable having an exposed section exposing a shield), inserting content into the stuffing tube, a content comprising a dry metallic conductor comprising multiple fibers and a two-part applicator mixed and injected curable mix comprising a resin and a hardener, such that at least some of the conductor is adjacent the exposed section of the cable. Rotating the gland nut into the stuffing tube until it squeezes the contents of the stuffing tube such that the gel spreads and the conductor grounds the metallic shield. The curable mix may include a gel having gel time of about 4-20 minutes, the curable mix may reach full cure in about 1-4 hours. The curable mix of the inserting step cures to a gel. The curable mix may be applied with an applicator that mixes the hardener and resin as it inserts it into the stuffing tube. The mix may have a viscosity of between about 1500 and 4400 cP (centipoise) when mixed and increases over time. The mix may have a viscosity of between about 20,000 and 65,000 cP when mixed and increases over time. The mix may have a viscosity of between about 1500 and 4400 cP (centipoise) when mixed and increases over time. The mix may have a viscosity of between about 20,000 and 65,000 cP when mixed and increases over time.

### BRIEF DESCRIPTION OF THE DRAWINGS

FIG. 1 illustrates the prior art stuffing tube assembly in cross-section.

FIG. 2 illustrates a side elevational view of Applicant's EMI shielding assembly, including the stuffing tube engaging a ship's deck (or a ship's bulkhead).

FIGS. 3A-3I illustrate the steps of providing an environmental seal with favorable EMI shielding to a stuffing tube carrying a cable therethrough, the views being elevational views of the stuffing tube through the deck carrying the cable, gland nut, and gasket of Applicant's present invention.

FIGS. 4A and 4B illustrate perspective and end views of a rope-like composite gasket for use with Applicant's stuffing tube assembly.

FIGS. 4C and 4D illustrate cross-sectional views, lateral and longitudinal, of a rope-like composite gasket for use with the stuffing tube assembly.

FIG. 5 illustrates a knitted wire mesh in top plan view that may be used as a metallic or conductive component of Applicant's composite gasket elongated member.

FIG. 6 illustrates one method for manufacturing an elongated, flexible, composite gasket member for use with Applicant's stuffing tube assembly.

FIGS. 7A, 7B, and 7C illustrate perspective views of a method of making Applicant's elongated, flexible, composite gasket member.

FIGS. 8 and 9 are cross-sections of pre-compressed (FIG. 8) and compressed (FIG. 9) condition of the stuffing tube assembly showing squeeze out of air, flow of gel, and crushing of metal fibers to generate electrically and the contact between the conductor and the shielding of the cable and the stuffing tube inner walls.

FIGS. 10, 10A, 10B, and 10C are perspective views of methods of making the gel/conductor composite.

FIGS. 11 and 12 are perspective and elevational views of a partly saturated gel/conductor composite.

FIGS. 13, 14, 15, and 16 are elevational views of a weatherproof wrapping for a stuffing tube and a method of making the same.

FIG. 17 is a cross-sectional view of the weatherproof wrapping.

FIGS. 18A and 18B illustrate an alternate preferred embodiment of an EMI protecting and weather and corrosion protecting stuffing tube assembly.

FIGS. 19A and 19B illustrate a composite gasket member wherein there is gel mostly around a perimeter.

FIG. 20 is an illustration of a method of controlling the rate of application of a gel to a release paper so as to approximate a known volume and/or weight of the applied gel.

FIGS. 21A, 21B, and 21C illustrate steps for determining a percent volume or weight of gel to conductor when making a composite gasket member.

### DETAILED DESCRIPTION OF THE PREFERRED EMBODIMENT

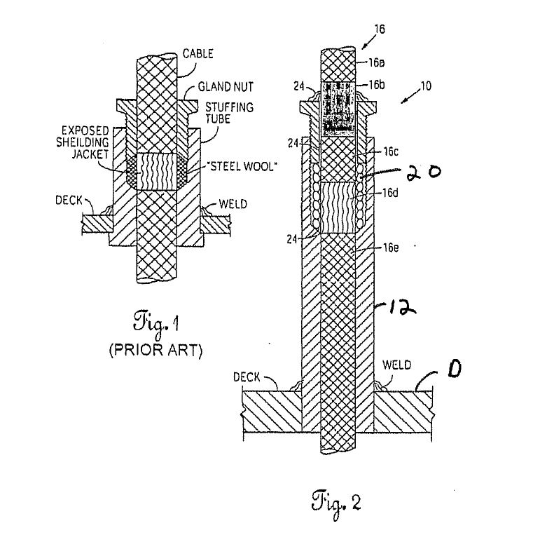

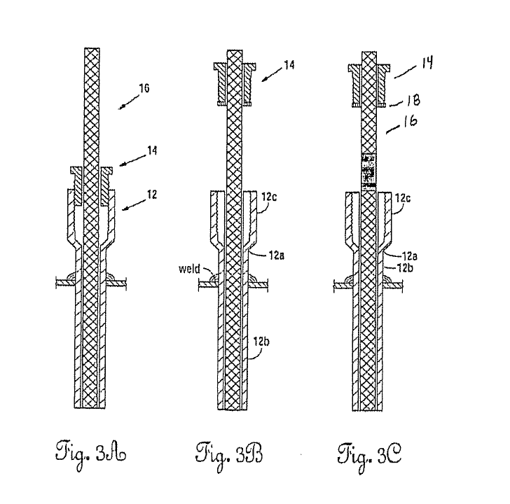

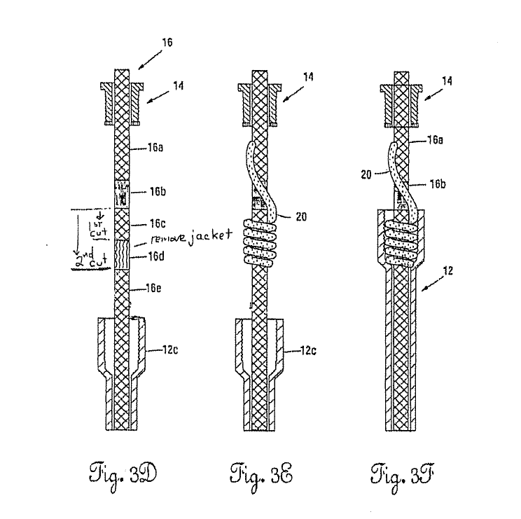

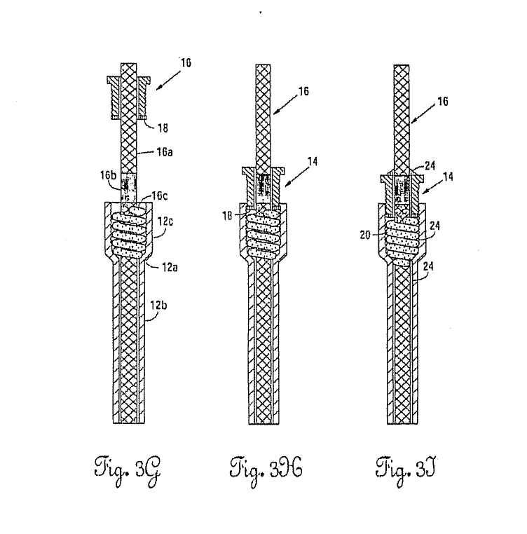

FIGS. 2, 3H, and 3I illustrate some of the structure and function of Applicant's EMI shielding gasket assembly 10. Applicant's EMI shielding gasket assembly 10 is seen to comprise a cable 16 running through a deck D by means of a fitting sometimes called a stuffing tube 12. Stuffing tube 12 is configured to allow a cable, including a cable bearing insulation and an EMI shield layer near the outer surface thereof, to pass through from one side of a deck to another side of the deck. Deck here refers to a tabular typically metallic member and includes what is traditionally understood to be a generally horizontal deck on a ship or submarine or other vehicle, but it also here used to include a generally vertical bulkhead member as often found on ships or submarines.

It is known that the interiors of ships often carry sensitive electronic equipment. This equipment often engages cables outside of the metallic shell defining the interior of the ship or a compartment thereof. One such cable is an antenna cable. The cables may be protected with a metallic conduit or they may simply run through a stuffing box and be grounded as in FIG. 1. If they run through a stuffing box, then an EMI shielding layer of the cable needs to be grounded to the stuffing box as the cable may carry EMI or an electromagnetic pulse or other interference. The sensitive electronic equipment found on the interior of the ship needs to be protected, thus some form of grounding between the cable and stuffing box is typically provided as, for example, see the prior art in FIG. 1.

Turning to Applicant's EMI shielding stuffing box gasket assembly 10, it is seen that the stuffing tube 12 may sometimes be configured with a pinched section 12a, below which is a cable section 12b having a diameter just sufficient to carry the cable therethrough. Above the pinched section is typically a cable/nut section 12c configured to receive not only the cable, but a larger diameter gland nut 14 to be received on the threads of the at least partially threaded cable/nut section 12c.

Deck “D” is typically metallic, typically tabular and steel, the stuffing tube being steel and the welds securing the stuffing box thereto. Grounding the cable, as shown in the prior art to the stuffing box elements thereof, grounds the shielding jacket and any substantial EMI signal or EMP signal carried thereon to the ship's deck, which acts as a grounding plane. In this manner, the electronic equipment in the interior of the ship is protected.

Cable 16, as it runs through stuffing tube 12, from above the stuffing tube to below decks, may be seen in FIG. 2 to have several sections. First, there is a section 16a of uncut or unaltered cable 16 for placement above and below fitting. A warning tape 16b of contrasting color is applied (adjacent top edge of 12c as seen in FIG. 2) and below that is an uncut section 16c sealed within stuffing tube. Section 16d has a cut, the cut exposing the shielding jacket of the cable by removing the insulation therefrom. Below the cut, section 16e (unaltered cable) is provided, which carries insulation thereon and extends through cable section 12b and below decks. A base stuffing tube washer 18 may be provided.

An elongated, flexible composite gasket 20, in some embodiments, comprising a gel and metallic conductor, is provided having a multi-strand or multi-fiber electrical conductor portion 22, typically being metallic or at least partially metallic (and may be in the form of a conductive or sometimes non-conductive mesh, knitted rope, or multiple fibers or strands, or the like), and a gel portion 24, typically being a soft, tacky, elastomeric flowable (when under compression) polyurethane gel for a good environmental seal. Electrical conductor portion is seen to comprise multiple conductive fibers or strands and multiple openings between the strands. In some embodiments, element 20 may be a non-conductor with the same multi-fiber construction, but used in environments where good moisture proofing is desired by conductivity is not needed. It is seen that cable 16 passes through gland nut 14 and stuffing tube 12 with the exposed section 16d substantially wrapped in the composite gasket 20 with the gland nut above and the constricted or pinched section 12a below. The position of the exposed section along the length of the cable is determined by placing a marker or tape 16b, such as a piece of tape or applied pigment, on the cable indicating the correct position and making cuts in the insulation surrounding the cable to expose conductive elements, such as metallic wire, in the cable.

The gland nut is torqued down and the soft, flowable (when under compression) gel portion 24 will be squeezed responsive thereto. This squeezes out much of the air and allows the gel flow somewhat to contact any annular portions between the inside of the gland nut and the exterior of the conductor, and portions of the filled space above the restrictor and below the gland nut with the flowable gel. The gland nut urges the gel flow, thereby helping to provide an effective environmental seal. At the same time, compression generated by gland nut torque allows the malleable wire filaments and strands of the conductive portion of the composite gasket 20 to be crushed and urged against both the jacket shielding and the metallic interior portion of the cable/nut section 12c (also referred to sometimes as stuffing tube bell).

Applicants wrap the composite gasket 20 tightly around at least the exposed portion 16d of the cable. Applicants feed the wrapped cable into the open end of the stuffing tube and firmly pack the composite gasket 20 into the tube and then torque the gland nut down. If there is a stuffing tube washer 18, it may be first inserted and slid down to the point up against the constriction. When the gland nut is torqued down, the gel flows, sealing voids in the tube nut and other portions of the assembly. Some gel may flow or squeeze out the top and bottom of the stuffing tube and make an excellent environmental seal. The cable will be grounded up to 360° around the exposed jacket shielding through the use of the compressed metallic mesh, as such providing excellent EMI/EMP protection. The gel allows the electrical conductive portion 22 to make electrical contact, but still encapsulates most of the wires of the mesh, not allowing voids for moisture which may cause galvanic corrosion.

Turning now to FIGS. 3A-3I, Applicants' environmental sealant and conductive gasket installation is described. In FIG. 3A, any preexisting sealing material is removed and the gland nut is removed to expose and separate the gland nut and stuffing tube. In FIG. 3B, the removal of the gland nut and gland ring away from the stuffing tube is illustrated. It may be necessary to hold the nut and ring with tape or other means against the cable, up and away from the stuffing tube junction with the deck.

FIG. 3C illustrates the placement of a piece of tape of contrasting color (to the insulation) around the cable immediately adjacent the top of the stuffing tube, to illustrate the placement of the gland nut and stuffing tube during torque down. At this point, any packing material or preexisting sealants may be removed from the previous insulation and the cable and exposed jacket cleaned and dried. If a bevel reducing adapter (not shown) is used, it should be clean and slid away from the stuffing tube and placed near the gland nut and any gland ring upstream or above the insulation.

FIG. 3D illustrates the cutting of the cable insulation. The Chart below shows the various tube sizes: A-F, G-J, K-R, and S-Z, along with the position of the first and second cuts, so as to locate exposed section 16d at the proper location adjacent the inner walls of the stuffing tube. Following the cutting, if a bevel reducing adapter is used, it should be installed into the stuffing tube and will be positioned generally downstream of exposed section 16d.

| Tube Size | 1^{st} Cut | 2^{nd} Cut |
|---|---|---|
| A thru F | 1⅝″ | 11/16″ |
| G thru J | 1 11/16″ | ¾″ |
| K thru R | 3″ | 1⅛″ |
| S thru Z | 5″ | 1¾″ |

FIG. 3E illustrates the manner of wrapping the conductive environmental and EMI sealing material composite gasket 20 around the exposed shield typically in a clockwise wrap when looking into the stuffing tube, such that torqueing down the gland nut tightens the coil of sealing material and squeezes out moisture and air.

FIG. 3F illustrates the step of pushing the wrapped cable with conductive sealant gasket material back into the stuffing tube and cutting off any excess material. Following the step illustrated in FIG. 3F, any additional material may be added to fill the stuffing tube bell, taking care not to damage the cable or expose shield material, after which the conductive/sealant gasket material 20 is trimmed to the proper length with scissors or similar tool. Tape section 16b may be used to locate the cable in the tube, such that the cut section 16d is positioned properly in the bell typically above the pinched section 12a.

FIG. 3H illustrates the installation of the gland ring (if present) and gland nut and FIG. 3I illustrates the torqueing down of the gland nut to the appropriate torque value.

Correct installation typically will satisfy the following conditions: two to three threads of gland nut are exposed; the cable does not slip when a modest tug is exerted; and the gland nut cannot be turned by hand.

If any of the conditions listed in the preceding step are not met, the installer may remove the gland nut and gland ring and repeat the instructions beginning with FIG. 3H, and install additional conductive environment gel sealing material 24.

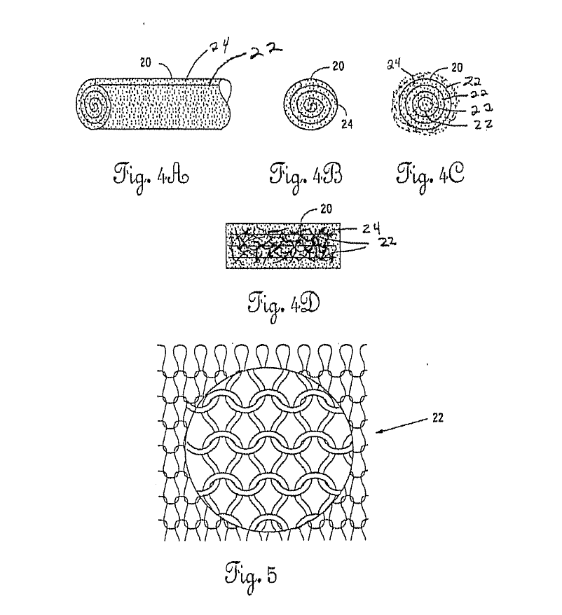

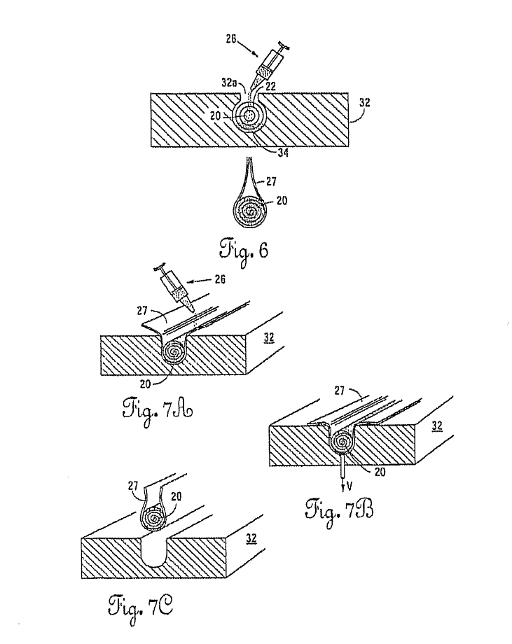

Gel/conductive composite gasket 20 may include electrical conductor portion 22, in one embodiment, a metallic, knitted rope as seen in FIG. 5, and available from Loos Wire Rope, Powfert, Conn. (USA). FIG. 5 shows the nature of the interlocking loops of the knitted wire mesh. Such rope may be ¼″, 5/16″, to 3 inches in diameter or other suitable size, and may have a general circular cross-section made up of multiple plies (see FIGS. 4A, 4B, 4C) or may be rectangular in cross-section instead of circular (see FIG. 4D). FIG. 4 also shows a multi-filament, wire electrical conductor portion 22, rather than a knitted wire. In one embodiment, the wire making up the rope may be about 3 to about 25 mil in diameter and may be aluminum, bronze, nomel, silver, plated metal, or the like. The term “mesh” is intended to include knitted, but also any multi-strand ordered (woven, knitted, etc.) or disordered (like steel wool, for example) arrangement of metal strands.

The gel may be the two part polyurethane gel described in AvDec U.S. Pat. Nos. 6,530,577; 6,695,320; and 7,229,516, which patents are incorporated herein by reference. The gel may be a two-part polyurethane gel, which is mixed and, before curing, impregnated or mixed into the portion 22, then allowed to cure.

Applicants provide a conductive/gel gasket 20, which in some embodiments is preformed and may have the following beneficial properties: elasticity, low water absorption, low water content, silicon leak-free, desiccation resistant, and high surface tackiness.

The elasticity and pliability, along with the flowability (under compression), makes an effective seal between two surfaces and helps seal over surface irregularities and irregularities that may be due to structural flexing or vibration.

Applicants' resilient gel portion 24 is typically comprised, post-curing, of a semi-solid, gel polyurethane, in one embodiment, typically between about 10 and 50 (10 mm) cone penetration. Surface tackiness allows some adhesion to the stuffing tube gland nut and cable conductive surface and jacket. The resilient gel portion 24 typically does not absorb more than about 1% of water by weight. Other resilient pliable gel bodies may be used, such as silicon or polyolefinic block co-polymers and other materials typically with similar core penetration and tackiness. Applicant's curable polyurethane mix is available from KBS Chemical of Fort Worth, Tex., as Part Nos. P-1011 (Polyol) and U-1010 (urethane). Other suitable environmental sealants may also be used.

An applicator 26 may be used in the method of formation of Applicants' gasket 20 as seen below. The applicator stores the liquid mix, typically as a resin (here, urethane) and a hardener (here, Polyol) in separate compartments in the body thereof. The nozzle allows the two compositions to mix as they are being applied (pre-cured). This step is illustrated, for example, in FIG. 6, where a mold 32 is provided having a groove, channel or cutout 32a therein. Into cutout 32a, the wire mesh knitted rope is inserted. Prior to insertion, a puddle 34 of uncured gel is injected at the bottom of mold 32. The liquid gel is applied and gravity allows it to fill at least up to about the neck portion of cutout 32a. A release film 27, which may be laid into the mold prior to laying in the wire rope or the puddle of gel, is used to lift the cured rope out through the neck. In another configuration (FIG. 7A), the mold is basically U-shaped (without constricted neck section).

FIGS. 7A, 7B, and 7C illustrate another method, similar to FIG. 6, except with a vacuum V drawn off the base of the mold. Release sheet 27 may be placed across the top after the liquid gel (uncured) has settled to about the top of the U-shape mold. Laying the release cloth across the top will cause it to suck down into and around the metallic rope or electrical conductor portion 22 impregnated with gel 24 as a vacuum is applied before curing. FIG. 7B illustrates release paper 27 laying on the mold. FIG. 7C illustrates the composite gasket member 20 being lifted out of the mold after the gel mix has cured.

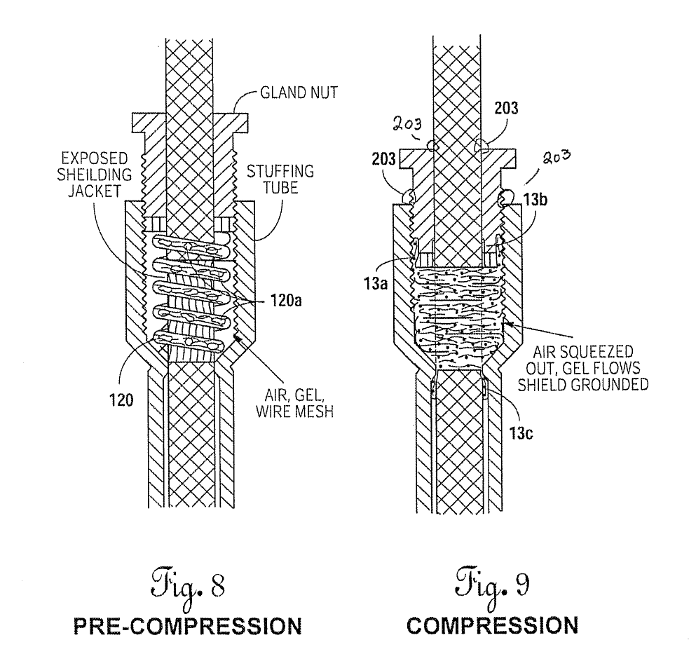

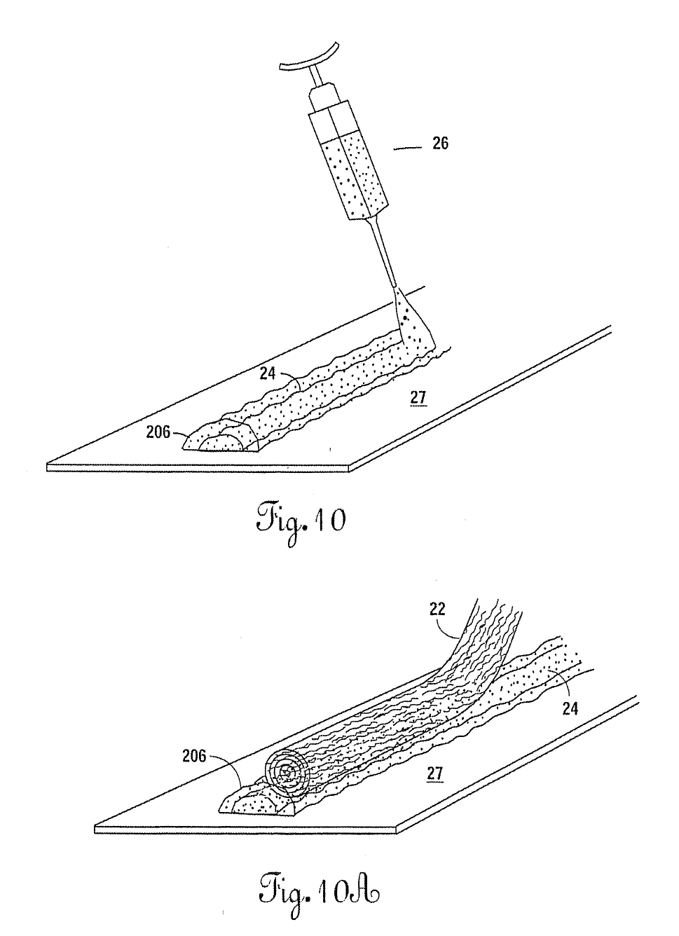

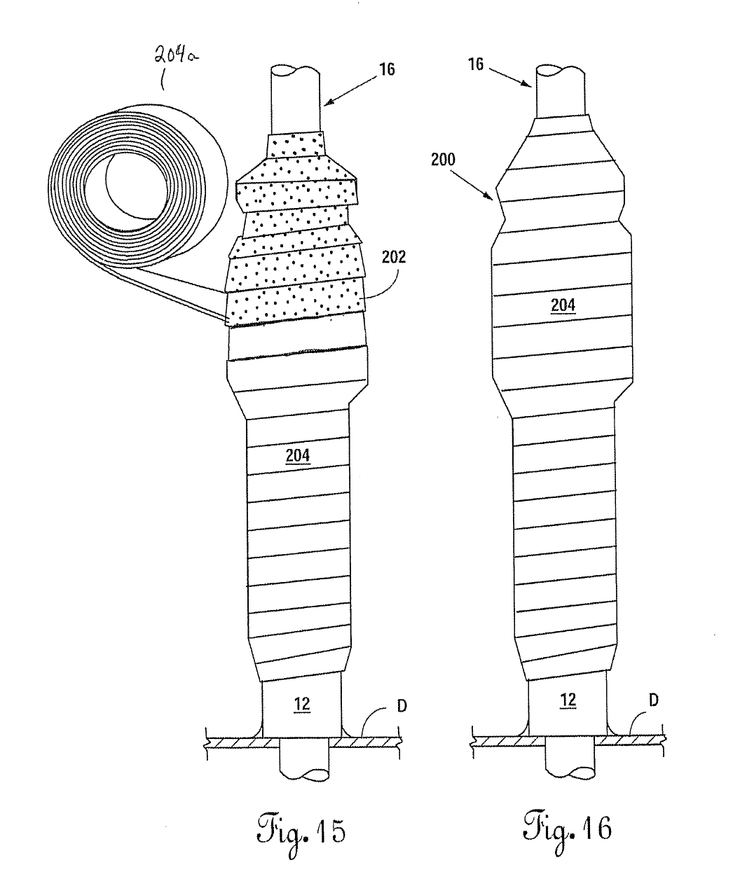

FIGS. 8-17 illustrate a number of features of stuffing tube assembly 10. Stuffing tube 12 is as seen in foregoing embodiments, as is cable 16. Composite gasket member (FIGS. 8, 10B, 11, 12, 19A, 19B) may be comprised of electrical conductor portion 22 and gel portion 24 which, in one embodiment 120, is only partly saturated with the gel to a predetermined gel volume percent or predetermined gel weight/conductor weight ratio, before assembly and tightening of the gland nut. Before placement into the stuffing tube (and tightening down of the gland nut), there are voids or air pockets 120a (areas without gel) (see FIGS. 11 and 12), such that when gland nut 14 is tightened down (see FIG. 9), most of the air gets squeezed out, with the air easily passing out of the gasket space—down through constriction or pinched section 12a or out gland nut threads and gland nut cable spaces. This leaves more room for the gland nut to be tightened down as compared to a partially saturated (about 10% or more of gel volume as air pockets) or encapsulated (less than 10% voids up to 0% voids) composite gasket 20.

FIGS. 13-17 illustrate a weather seal assembly 200 that may be used with any stuffing tube assembly, including without limit prior art or any of those embodiments set forth herein. Weather seal assembly 200 includes at least two layers, a tacky gel/foam first or inner layer 202 for creating a good environmental, weatherproof seal on the outside of the stuffing tube, and a rubber, weather and U.V. resistant second or outer layer 204 for helping seal and protect the inner layer and further protect the areas where the gland nut meets the stuffing tube and where the cable enters the stuffing tube. The weather seal assembly typically covers at least these two areas that might otherwise allow moisture to seep in. Inner layer 202 typically seals off the air gaps around the circled areas 203, in FIG. 9. The layers may come from tape 202a/204a and are typically applied from tape, see FIG. 13 (first layer 202 applied as tape), and FIG. 15 (second layer 204 applied as tape).

When a stuffing tube requires a waterproof wrap, Applicant's weather seal assembly 200 as seen in FIGS. 13-17 may be used. One tacky, typically stretchable gel, inner layer 202 that may be used is Av-Dec's Stretchseal Tape, Part No. AD 89503 (Av-DEC, fort Worth, Tex.), which has a pre-cured, flame retardant polyurethane gel with a 35 gr. half cone penetrometer hardness of about 95-104, similar to the gel described in the patents incorporated herein by reference. In making the inner layer, uncured gel is applied to an open cell foam, stretchable (up to about 150%) so it is substantially saturated with the gel. Upon curing, the inner layer retains its tacky and sticky gel properties between about −85° F. and 275° F. and stretchability. It typically comes as tape 202a and is stretched as applied.

As seen in FIGS. 13 and 14, inner layer 202 which may be gel/foam is applied as a first layer to the outer surface of the stuffing tube, which should be clean and dry before application of this first course. Before this, optionally, uncured gel 24 may be applied to the stuffing tube as seen in FIG. 2 and/or may be applied to circled areas 203, see FIG. 9. As the first or inner layer 202 is tacky and stretchable, it will stick when applied and can be stretched while being applied so as to make a tight, closefitting environmental and moisture proof seal against the stuffing tube outer surface. It is preferably wrapped bottom to top with the moisture shedding overlap as seen in FIG. 13. This layer has excellent adhesion to itself (cohesion) to allow for moisture proofing. Typically, when applied, the gel of the inner layer is fully cured. Inner layer 202 is typically an electrical insulator, and is non-reactive to the metal of the stuffing tube (which is usually steel).

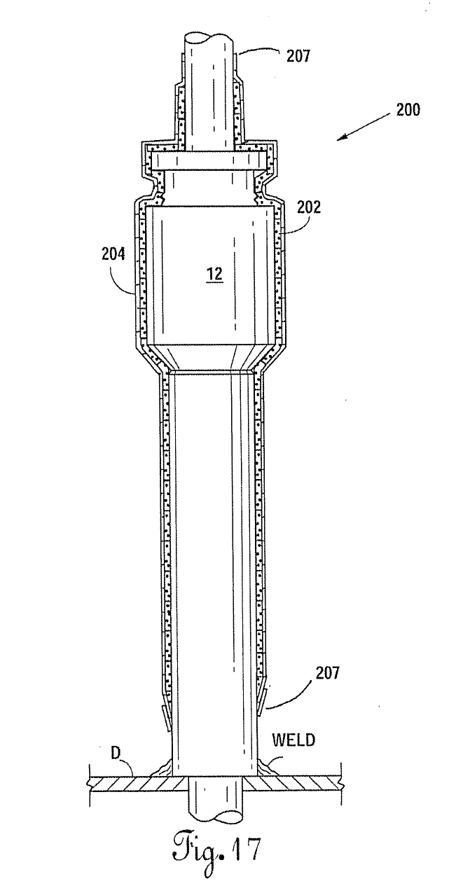

Weather resistant outer layer 204 may be a waterproof adhesive tape 204a that may also be UV (ultraviolet) resistant. One such tape is a self-fusing, silicone rubber tape that will adhere to itself, is waterproof, and substantially airtight when forming an overlapping layer tight to a surface. One such tape is Av-Dec AD 59163, about 1″ wide and about 0.020″ thick (unstretched). It may stretch to 300% or more, and is typically stretched when overlapping first or inner layer 202, to provide a tight seal against the inner layer. Outer layer 204 may extend to areas 207, beyond the longitudinal extent of coverage the inner layer (see FIG. 17). It is typically an electrical insulator and retains its flexible and waterproof properties between about −130° F. to about 500° F. It may be wrapped in the same manner as the first layer—in a water shielding overlap. In one embodiment, it may be self-fusing, becoming a cogent, fused mass after about 24 hours.

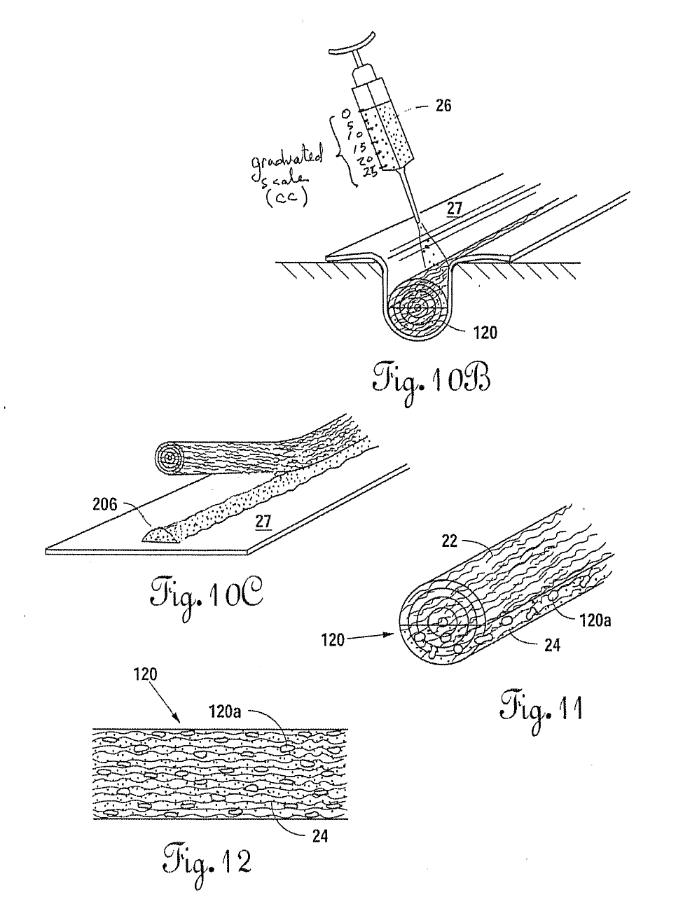

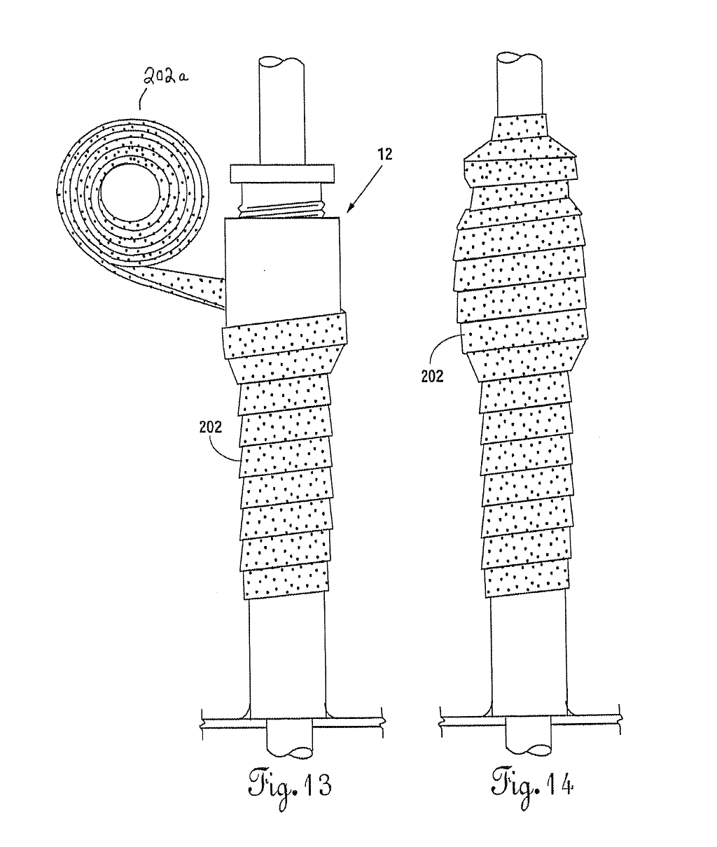

FIGS. 10, 10A, 10B, 10C, 11, 12, 19A, 19B, 20, 21A, 21B and 21C add both details to the method of making composite gasket members in various embodiments and alternate methods.

In FIG. 10, the one or more lines 206 comprising the bead of uncured gel is drawn across a flat sheet of release paper 27 rather than the trough of FIG. 10B, for example. The dry electrical conductor portion 22 (which in one embodiment may be a mesh rope and in other embodiments may be a non-conductor such as fiberglass mesh) is then laid on the bead and allowed to sink into the gel as it cures, see FIG. 10C. Following curing, the composite member 20 is removed and/or, with release paper still on it, is delivered to the jobsite for use with a stuffing tube. Alternatively, the dry portion is laid down on the release sheet and gel applied to it with applicator 26.

Turning to FIGS. 11 and 12, one can see that a partially saturated composite member 120 may include air and air pockets 120a, before compression by gland nut 14 (see FIG. 9). Compression by the gland nut during assembly can squeeze out most of the air and “spread” deformable (but not compressible in bulk) gel 24 into adjacent areas, such as areas 13a/13b/13c (these areas are typically above the restriction and below the bottom of the tightened gland nut) as seen in FIG. 9.

In one embodiment, when the cross-sectional area of the rope is considered, as an ideal “circle” as seen, for example, in FIGS. 6 and 10A, and ignoring the area inside the outer circumference of this “circle” taken up by the fiber end cross-sections, the volume amount of gel may be expressed in terms of a percentage of this area. In one range, it is about 10-30%, another range about 10-50%, in another range about 30-70%, and in other ranges greater than about 20% or greater than about 50%. This percentage may be qualitatively estimated by the gasket maker when making a visual examination of the end of the dry mesh rope or electrical conductor portion 22 as it is roughly circular or checking the spec sheet on the dry metal rope for area and density. The maker may then either assert sufficient force and linear speed to applicator 26—to achieve the estimated gel volume needed for a predetermined range or may observe the mix of a known volume. Compare, for example, bead of gel 24 in FIGS. 10 and 10A, that will give a higher percent of gel, to the smaller bead of FIG. 10C. The bead of FIG. 10C, for example, might yield composite member 120 as seen in FIG. 11 (in the lower gel percentage ranges under 50% gel). Further methods of pre-determining a selected volume range may be found below.

FIGS. 10, 10A, and 10C show a method of making flexible at least partly saturated composite member 20 wherein beads 206 of gel 24 are applied to flat laying release film 27 from applicator 26. Before the gel cures, conductor portion 22 is hand laid on top of the bead and allowed to sink in. The composite member results when the gel cures and is pulled off the release sheet or is rolled up in the release sheet, ready to use. FIG. 10B illustrates the “trough” method of forming composite 120 with conductor portion 22 partly saturated, as opposed to the “bead” method of FIGS. 10, 10A, and 10C.

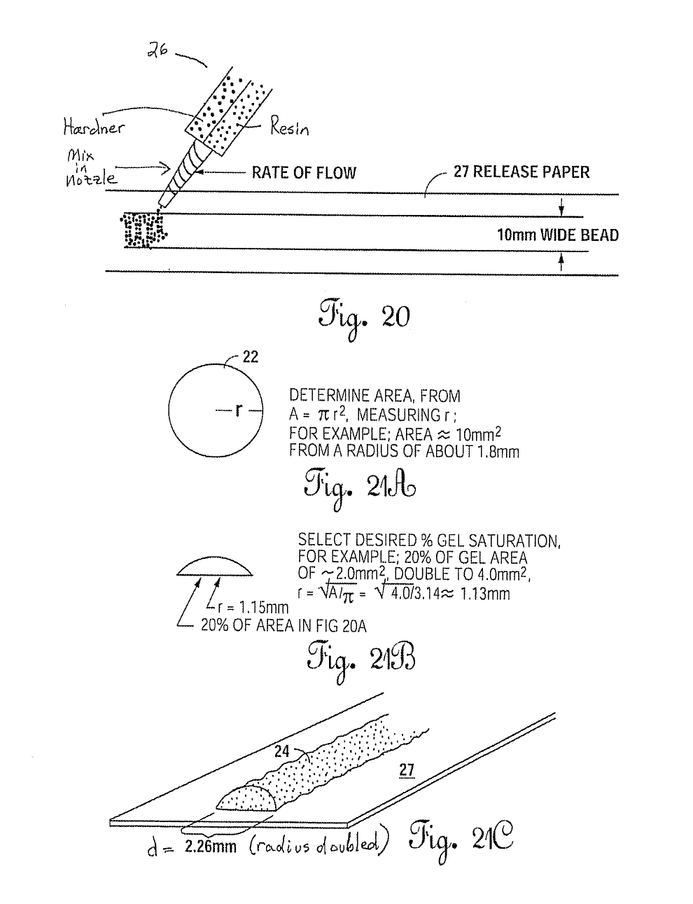

FIG. 20 illustrates in a quantitative manner the manner in which, either mechanically or manually, a controlled flow from applicator 26 can yield a controlled, known volume of gel. It is assumed that the cross-sectional area of the bead is about half the area of a circle (an end view of the bead yields a half circle, see FIG. 21C, for example). Multiplying area by the length of the bead results in the volume of gel. Independent variables controlled by user/machine are pressure on the applicator and speed of applicator. One can also cut the tip to change the amount of gel flow rate out the nozzle at a given force, but once cut, the only variables for the volume of gel deposited are speed of the applicator and force on the forcing element. With some practice, one can get fairly accurate in controlled volume application. In another method, the volume of contents of the applicator is known, for example, one applicator has 50 cc total (25 cc of hardener, 25 cc of resin), another has 100 cc (50 cc of hardener, 50 cc of resin). Laid down on a release sheet, and combined with a known volume of conductor rope (ignoring fiber cross-sections as same length as bead of known volume) yields a predetermined volume ratio.

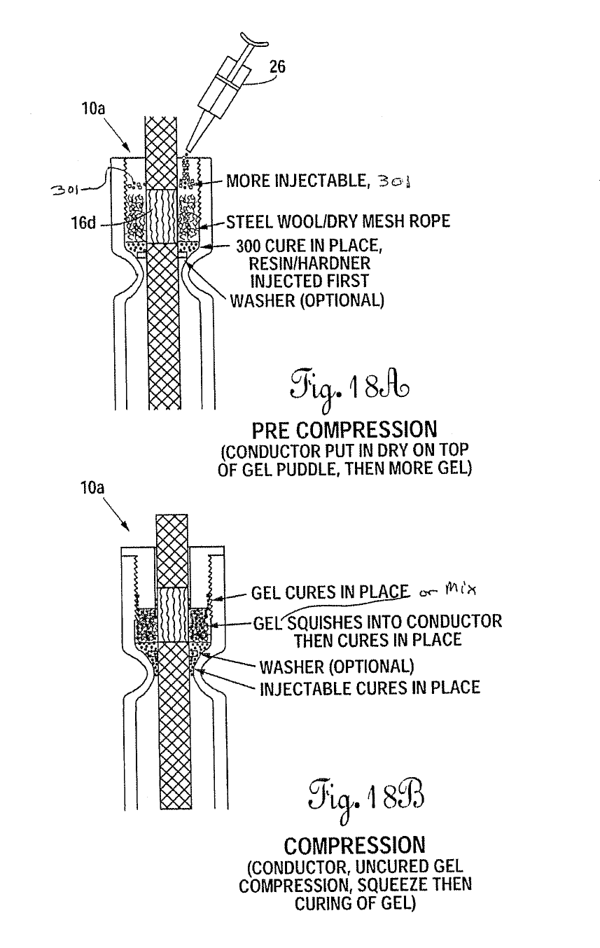

FIGS. 18A and 18B illustrate, pre-compression and compression, an embodiment of Applicant's invention which does not use the partially or fully saturated (encapsulated) composite gasket member 20 as set forth in some of the earlier embodiments. Instead, it uses, in the assembly process, either dry multi-filament steel wool 130 (or the like) or dry mesh rope electrical conductor 22 (or some other suitable, usually multi-fiber, dry electrical conductor) jammed into the stuffing tube and around the exposed metal shield of cut section 16d. The dry steel wool 130 or dry mesh rope electrical conductor 22 is usually inserted after a lower or first injection, puddle 300 of a two-part (resin, hardner) injectable cure-in-place mix is shot into or above the area where the constriction in the stuffing tube meets the cable (optionally, a washer may be here) and in the gland nut area generally—though not too much, as room is usually needed to add the dry metallic conductors 130/22 and more pre-cured gel mix. After creating first or lower puddle of first injections 300 of injectable uncured mix (and preferably before the mix hardens), the dry metallic conductors 130/22 (typically steel wool or dry mesh rope) are urged in, typically by hand and “on deck” (at the worksite). This is followed, optionally, with a second injection 301 of the same or a different uncured mix, such as an uncured injectable gel having a lower viscosity. Following this second application 301 of uncured mix, is a tightening down of the threaded gland nut. Tightening down the gland nut will squeeze some of the uncured gel of injections 300/301 around the areas of the thread, and around the cable where it goes through the stuffing tube and around and through at least some of the dry metallic conductor (also “wetting” the mesh rope or steel wool to help prevent corrosion). In one embodiment, the mix will set or being to cure in about 4 to 20 minutes from mixing in the applicator nozzle and ends up providing a good environmental seal with the conductor portion providing a good ground from the shielding jacket of the cable to the stuffing tube (for EMI protection). When the gland nut is screwed down or torqued, it squeezes some of the uncured gel around and through the wires of the mesh or steel wool and the stuffing tube, the cable, and the threads.

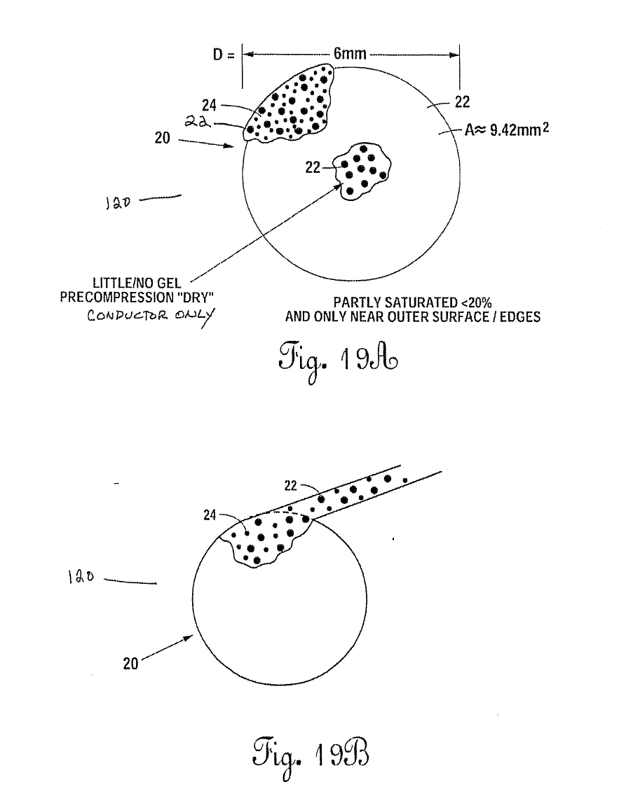

FIGS. 19A and 19B illustrate an embodiment of the partially saturated gel/conductor 120, wherein most of gel 24 is limited to the very outer shell area of the cross-section as seen in FIG. 19A. In other words, there's just an outer coating of the gel, typically less than about 20% gel by volume (or area of cross-section) and/or about the outer one quarter or less of the radius of the cross-section. For example, if the radius is 1.2 mm, the gel will be mostly in an area within about 0.30 mm of the perimeter. FIG. 19A also illustrates a method of calculating percentages of gel volume/area saturation for a rope-shaped metallic conductor for making a composite gasket member 20 with a predetermined gel volume percentage. This includes taking the diameter of the area of the rope, here, for example, 6 mm. That yields a cross-sectional area—ignoring the metal fibers, of about 28.3 mm². This is partially saturated less than about 20% volume when the partially saturated rope, when looked at in cross-sectional area, has an area of gel that is less than about 5.65 mm² (20% of 28.3 mm²). In one embodiment, that volume of gel is substantially limited to the outer shell; in another, it is spread throughout the conductor.

Another way to calculate the volume percentage range of gel is to determine, by weighing, the weight of a given length of dry conductor of a given cross-sectional area. Then add the gel to the given length and weight of the composite gasket member 20, the difference before and after will be the weight of the gel. Given the known volume of the available area of rope and the volume of the gel (calculated by gel weight and known gel density or directly measured out from applicator), one can determine the percentage of gel in the volume of rope and the percentage gel to mesh.

As can be seen in FIGS. 20, 21A, 21B, and 21C, a method of depositing a known volume/weight of gel is shown. If the cross-sectional area of the rope were about 10 mm² and a desired saturation is about 20% saturation, take 20% of 10 mm² which is 2.0 mm², double it, because only a half circle of gel is deposited in forming the bead, so 4.0 mm²=(3.1416)r², solve for radius, in this case about 1.13 mm (2.26 dia). Mark that diameter with a grease pencil or otherwise on the release paper and run your semi-circular bead with a controlled pressure on the forcing element of the applicator and a controlled speed to the required length.

More conductor and less gel (assuming most of the air is squeezed out) in the same space below the gland nut—means greater grounding contacts and greater EMI protection. In one embodiment, the conductor/gel weight ratio is in the range of about 30/70 to 70/30, for both effective EMI protection (mesh or conductor) and environmental seal (gel).

A predetermined weight ratio can be determined by weighing a length of dry rope before combining with uncured gel, then calculating the volume of gel needed for a desired gel weight to dry conductor weight. Knowing the density of the gel will determine the volume needed to be applied—the length known from the length of the dry rope. In one embodiment, a graduated (scaled) two-part applicator is used (see scales, FIG. 10B). For predetermined weight, for example, consider density of steel 8.0 gr/cc, density of polyurethane gel is about 1 gr/cc. If 160 grams of dry rope is used and a 40/60 gel/mesh weight ratio is desired, the total weight of composite member 160/.6=267 grams total, 267−160 (rope)=107 grams of gel. One may determine the volume of gel from gel density which volume in the example ≈107 cc, for

As to your weight ratio of mesh to gel, more mesh gives you better grounding and better EMI protection, but more gel gives you better environmental and corrosion protection in a range of about 30/70 to about 70/30 may be effective. To determinate, weigh rope before soaking, determine the weight of the gel desired from its known density and the volume as set forth in the previous paragraphs and then mix. One could weigh the dry rope before, then after soaking, to determine whether or not the composite is in the range selected. This is just another way to get the right amount of conductor/gel mix for optimum EMI. In one embodiment, partially saturated means a gel/weight ratio of less than about 80/20 by weight.

An example method of making an EMI and environmental friendly stuffing tube assembly from a stuffing tube and gland nut, includes, with a gland nut removed and a cable running through a stuffing tube, the cable having an exposed section exposing a shield, inserting content into a stuffing tube, the content comprising a dry metallic conductor comprising multiple fibers and a two-part curable mix comprising a resin and a hardener. At least some of the conductor is adjacent the exposed section of the cable. The gland nut is placed on the stuffing tube and rotated until it squeezes the contents. The curable mix may include a gel having gel time of about 4-20 minutes. The curable mix may reach full cure in about 1-4 hours. The curable mix of the inserting step may cure to a gel. The curable mix may be applied with an applicator that mixes the hardener and resin as it inserts it into the stuffing tube.

The mix has a viscosity of between about 1500 and 4400 cP (centipoise) when mixed and increases over time. One such mix is AvDec Self Leveling Green, HT 3326-5 (about 1500-2500 cps Resin, 3300-4300 cP hardness). A mix may have a greater, for example, viscosity of between about 20,000 and 65,000 cP when mixed and which increases over time. The “harder” more viscous mix may be inserted first, followed by the dry metallic conductor, followed by the less viscous mix. One such more viscous mix is AvDec Thixoflex orange or gray, TG 8498 or TF 2219 (hardner 50-65,000 cP, resin 20-30,000 cP).

Although the invention has been described with reference to specific embodiments, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A method of making a rope-like composite gasket member, the method comprising the steps of:
providing a long, flexible rope member having multiple strands and multiple openings between the strands; the rope member with a longitudinal axis and an outer surface;
combining the rope member with a curable, sticky gel.

2. The method of claim 1, wherein the rope member of the providing step is comprised of a cylindrical, knitted, wire mesh.

3. The method of claim 1, wherein the curable, sticky gel of the combining step is a two-part polyurethane gel.

4. The method of claim 3, wherein the rope member of the providing step is comprised of a cylindrical, knitted, wire mesh and the gel of the combining step is a two-part polyurethane gel.

5. The method of claim 4, wherein the combining step results in encapsulation of the rope member.

6. The method of claim 1, wherein the combining step results in partial saturation of the rope member.

7. The method of claim 4, wherein after the providing step is the step of placing the rope member in a mold.

8. The method of claim 7, wherein the combining step includes combining the polyurethane gel as an uncured mix and allowing it to cure.

9. The method of claim 8, wherein the mold is lined with a release sheet.

10. The method of claim 1, wherein the rope member of the providing step is an electrical conductor.

11. The method of claim 1, wherein the rope member of the providing step is a non-conductor.

12. The method of claim 1, wherein the combining step occurs on a horizontal release sheet.

13. The method of claim 1, wherein the combining step occurs in a mold.

14. The method of claim 1, further including the step of determining a gel to void ratio and wherein the combining step includes the step of combining the rope member and gel in the predetermined ratio.

15. The method of claim 1, further including the step of determining a gel to rope weight ratio.

16. A method of making a rope-like composite gasket member, the method comprising the steps of:
providing a long, flexible rope member having multiple strands and multiple openings between the strand(s); the rope member with a longitudinal axis and an outer surface;
determining a gel to wire mesh weight ratio or a gel to gel void volume ratio; and
combining the rope member with a curable sticky gel to about the predetermined ratio.

17. The method of claim 16, wherein the combining step occurs on a horizontal release sheet.

18. The method of claim 16, wherein the combining step includes combining the polyurethane gel as an uncured mix and allowing it to cure.

19. A method of making a rope-like composite gasket member, the method comprising the steps of:
providing a long, flexible rope member having multiple strands and multiple openings between the strand(s); the rope member with a longitudinal axis and an outer surface;
combining the rope member with a curable sticky gel;
wherein the rope member of the providing step is comprised of a cylindrical, knitted, wire mesh;
wherein the gel of the combining step is a polyurethane gel; and
wherein the combining step results in only partial saturation.
